(19) United States
(12) Patent Application Publication
(10) Pub. No.: US 2005/0215320 A1
(43) Pub. Date: Sep. 29, 2005

(54) Optical game controller

(76) Inventors: Ban Kuan Koay, Penang (MY); Shamoon Shabudin, Penang (MY); Ming Yong Mau, Penang (MY); Chiang Sun Cheah, Penang (MY)

Correspondence Address: AGILENT TECHNOLOGIES, INC.;Legal Department, DL429, Intellectual Property Administration, P. O. Box 7599, Loveland, CO, 80537-0599, US

(21) Appl. No.: 10/810,154

(22) Filed: Mar. 25, 2004

(51) Int. Cl. A63F 13/00

(52) U.S. Cl. 463/37

(57) ABSTRACT

A game controller having a moveable element and an imaging element that forms an image of a portion of the surface of the moveable element is disclosed. The moveable element has an optically readable pattern on a surface thereof and moves relative to a fixed position. The position of the moveable element at any given time is characterized by the relative position of the moveable element relative to a fixed reference position. The imaging element forms an image of a sub-area on the surface. The sub-area is determined by the relative position of the moveable element relative to the fixed position. A memory stores a map that specifies the readable pattern in each sub-area on the surface that can be imaged by the imaging element. A controller compares the image to the map to determine the position of the moveable element.

### FIELD OF THE INVENTION

The present invention relates to pointing devices, and more particularly to game controllers.

### BACKGROUND OF THE INVENTION

Computer games preferably utilize a game controller that is different from the pointing devices utilized on most computers. Consider a game in which an army tank moves around a two dimensional scene on the computer monitor and shoots at various moving targets with a gun mounted on the tank. The game requires two degrees of linear motion to move the tank within the scene and one degree of motion to rotate the gun relative to the tank. In principle, the linear motion can be controlled by a conventional mouse. However, specifying the degree of rotation of the gun in a continuous manner cannot be implemented from the mouse's movement.

In addition, the mouse only provides a signal that specifies an incremental displacement from the last position recorded by the computer. As a result, there is not always a one-to-one correspondence between the position of the mouse within the mouse's field of motion on the desk and the objects position on the screen. For example, consider the case in which the object being moved reaches the edge of the screen and the user continues to move the mouse in the same direction. The object on the screen does not move further in response to the mouse's motion once it reaches the limit of the screen. When the mouse is moved backward, the object again moves, but the mapping between the mouse's field of motion on the desk top and the screen objects field of motion on the monitor has now changed. Such changes in the mouse mapping make it difficult to precisely control the object at the very high speeds inherent in many games.

Hence, game controllers are preferably used to control objects in games. Such game controllers typically consist of a joystick which can be moved in two orthogonal directions as well as being rotated. The various positions of the joystick map to corresponding absolute positions on the screen. Hence, when the joystick is centered, the object is always at the same location on the screen. Similarly, the rotation of the joystick can be mapped to the rotation of the object on the screen such that there is a one-to-one correspondence between the rotation of the object and the rotational position of the joystick.

Prior art joystick mechanisms typically use potentiometers to convert the joystick position to an electrical signal that indicates the absolute position of the joystick. The coupling mechanism between the joystick and the potentiometers is mechanically-based and requires a significant number of parts that are subject to wear. The large number of parts and the mechanical assembly thereof increase the cost of the devices. The lifetime of the joystick is set by the wear to which the parts are exposed. In addition, the relatively small market for joysticks, as opposed to pointing devices such as the mouse, make it difficult to reduce the cost through mass production.

### SUMMARY OF THE INVENTION

The present invention includes a game controller having a moveable element and an imaging element that forms an image of a portion of the surface of the moveable element. The moveable element has an optically readable pattern on a surface thereof and moves relative to a fixed position. The position of the moveable element at any given time is characterized by the relative position of the moveable element relative to a fixed reference position. The imaging element forms an image of a sub-area on the surface. The sub-area is determined by the relative position of the moveable element relative to the fixed position. A memory stores a map that specifies the readable pattern in each sub-area on the surface that can be imaged by the imaging element. A controller compares the image to the map to determine the position of the moveable element. In one embodiment, the pattern includes a plurality of randomly distributed spots. In one embodiment, the controller generates a signal indicative of a position of the spherical element in terms of first and second orthogonal displacements from a reference position, and the rotation of the moveable element about a predetermined axis on the moveable element. In one embodiment, the moveable element includes a handle having a shaft with a shaft axis parallel to the predetermined axis. In one embodiment, the map is divided into a plurality of sub-maps that are rotated relative to one another. In one embodiment, the controller includes a plurality of search processors, each search processor comparing a portion of the map with the image formed by the imaging element.

### BRIEF DESCRIPTION OF THE DRAWINGS

FIG. 1 illustrates a game controller according to one embodiment of the present invention.

FIG. 2 illustrates a multi-processor system for searching the sub-maps of one embodiment of the present invention.

### DETAILED DESCRIPTION OF THE PREFERRED EMBODIMENTS OF THE INVENTION

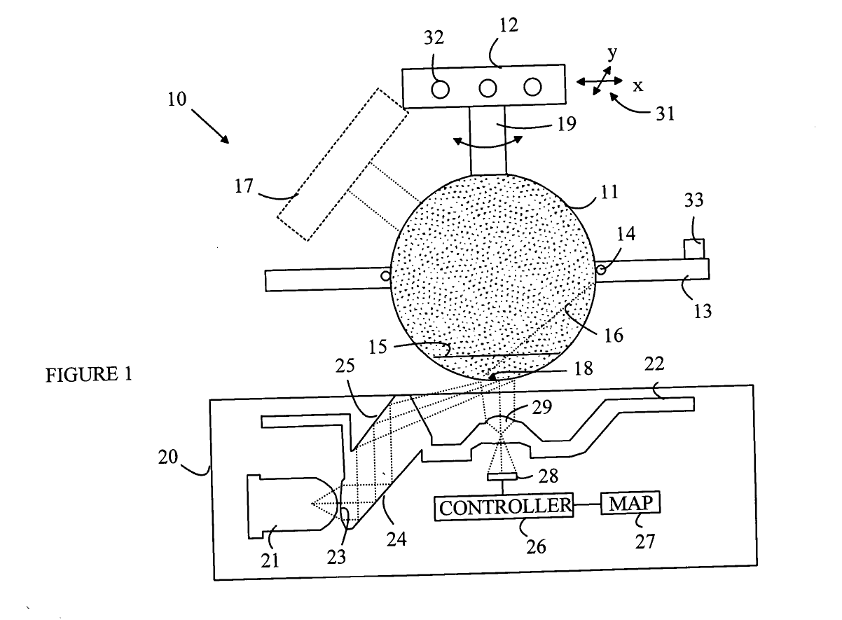

The manner in which the present invention provides its advantages can be more easily understood with reference to FIG. 1, which illustrates a game controller 10 according to one embodiment of the present invention. Game controller 10 includes a spherical element 11 that rotates in a housing 13. A handle 12 is mounted on spherical element 11 via shaft 19. When a force is applied to handle 12, spherical element 11 rotates in housing 13. The force can be a linear force that causes handle 12 to move forward, backward, or side-to-side as shown by the arrows at 31. In addition, spherical element 11 can be rotated around shaft 19.

The bottom surface of spherical element 11 has a pattern printed thereon. The pattern is chosen such that an image centered about any point on the patterned surface is unique, and hence, can be used to identify the point in question. An imaging system 20 illuminates a small area on the portion 18 of spherical element 11 that is adjacent to the imaging system and generates an image of the illuminated area. The image of that portion is then compared to a map stored in memory 27 within imaging system 20 to determine the area that is being imaged. The identity of the area being imaged is used to compute the x and y displacements of handle 12 and the amount of rotation of spherical element 11 around shaft 19 that would be needed to produce the observed image.

Any pattern that provides an image to imaging system 20 that allows controller 26 to determine the displacement and rotation can be utilized. For example, a random pattern of spots such as shown in FIG. 1 can be utilized for this purpose. While the pattern on spherical element 11 shown in the drawing covers the entire spherical element, only the portions that are within view of imaging system 20 at one of the possible x and y displacements need to be covered. The line shown at 15 in the drawing represents the boundary between the viewable region and the remainder of spherical element 11.

As noted above, spherical element 11 is mounted in a housing 13 that allows spherical element 11 to move freely over the possible displacements and rotations while its center remains in a fixed relationship with respect to imaging system 20. The housing may include one or more bearings 14 that facilitate the motion and minimize the wear to which the surface of spherical element 11 is exposed. However, spherical element 11 will be exposed to some wear that will alter the surface in the areas at which spherical element 11 contacts housing 13. If this wear alters the pattern on the bottom surface of spherical element 11 in the regions used by controller 26 to identify the displacement and rotation, the lifetime of the game controller will be adversely effected. To minimize the effects of such wear, the contact points of housing 13 are preferably positioned such that the portion of spherical element 11 that is used by imaging system 20 does not make contact with the contact points at any of the available displacements or rotations of spherical element 11. That is, when spherical element 11 is moved to its maximum displacement as shown at 17, the portion of the surface that is used by the imaging system remains outside housing 13's contact points as shown at 16.

Imaging system 20 includes a light source 21 and an imaging array 28. An optical element 22 provides the lens and reflectors needed to project the light from light source 21 onto the portion of spherical element 11 nearest to imaging system 20. In the embodiment shown in FIG. 1, this is accomplished via lens 23 and the two reflecting surfaces shown at 24 and 25. Optical element 22 also includes an imaging lens 29 for imaging the illuminated portion of spherical element 11 onto imaging array 28. Optical element 22 is preferably a plastic casting made from a clear material. To simplify the drawing, the support structures in imaging system 20 to which optical element 22 and the other components are mounted have been omitted.

While a custom imaging element can be utilized in the present invention, it should be noted that imaging system 20, with the exception of controller 26 and the map stored in memory 27, is similar in structure to the imaging systems used in optical mice. Hence, the present invention can utilize a slightly modified version of an optical mouse imaging system to reduce the cost of the present invention relative to prior art game controllers.

As noted above, the present invention stores a map of the pattern on the surface of imaging element 11. The map is preferably stored in a non-volatile memory 27 connected to controller 26. Assume for the moment that spherical element 11 does not rotate about shaft 19. In this case, the map is preferably an image of the region of the surface of spherical element 11 that can be seen by imaging array 28. At any given displacement, imaging array 28 “sees” a small portion of the image stored in memory 27. Controller 26 must, in effect, find the location of this smaller image in the large image stored in memory 27. In one embodiment of the present invention, controller 26 determines the location by testing a number of possible locations. For each test location, the sub-image in memory 27 that is of the same size as that recorded by imaging array 28 is compared to the image measured by imaging array 28. If the images match to within some predetermined error threshold, the displacement in question is assumed to be the correct displacement. If the images do not match to within the error threshold, a new test displacement is chosen and the process repeated.

Any of a number of algorithms can be used to measure the match between the image measured by imaging array 28 and the sub-image from the map in memory 27. For example, in one embodiment, the correlation of the two images is computed. In another embodiment, the two images are subtracted from one another after the images have been appropriately normalized.

In embodiments in which spherical element 11 can also rotate about shaft 19, the search process described above must also be repeated for each of a number of possible rotations of spherical element 11. In principle, either the image from imaging array 28 or the map stored in memory 27 can be rotated by the test rotation prior to making the image comparison.

While the computational workload imposed by rotating the entire map of the surface of spherical element 11 is much greater than that imposed by rotating the image generated by imaging array 28, it should be noted that this workload need only be done once for each possible test rotation. In one embodiment of the present invention, memory 27 includes a plurality of rotated maps. Each map includes the entire image of the surface of spherical element 11 that can be seen by imaging array 28 after the test rotation is applied. When controller 26 needs to compare the measured image with the stored map after a particular test rotation has been applied, controller 26 merely selects the rotated map corresponding to that test rotation, and proceeds to search that rotated map for a match to the measured image.

It should also be noted that the comparison process for the various possible test rotations can be carried out in parallel to further reduce the time needed to find the current rotation and (x,y) displacement of spherical element 11. In one embodiment, controller 26 includes a plurality of comparison processors. Each comparison processor operates on a different rotated map at any given time, and reports the best fit found on the current map to a central processor within controller 26.

A similar parallel processing strategy can be utilized to reduce the time needed to find the best match within each rotated map. In one embodiment, each rotated map is further sub-divided into a plurality of search sub-maps. The sub-maps are obtained by dividing the original map into a plurality of regions. Each sub-map includes one of the regions together with the area surrounding that region that could be seen if the displacement of spherical element 11 was on the boundary of that region. A plurality of processors operate on the collection of sub-maps. Each processor operates on a different sub-map at any given time and reports its best fit to the central processor.

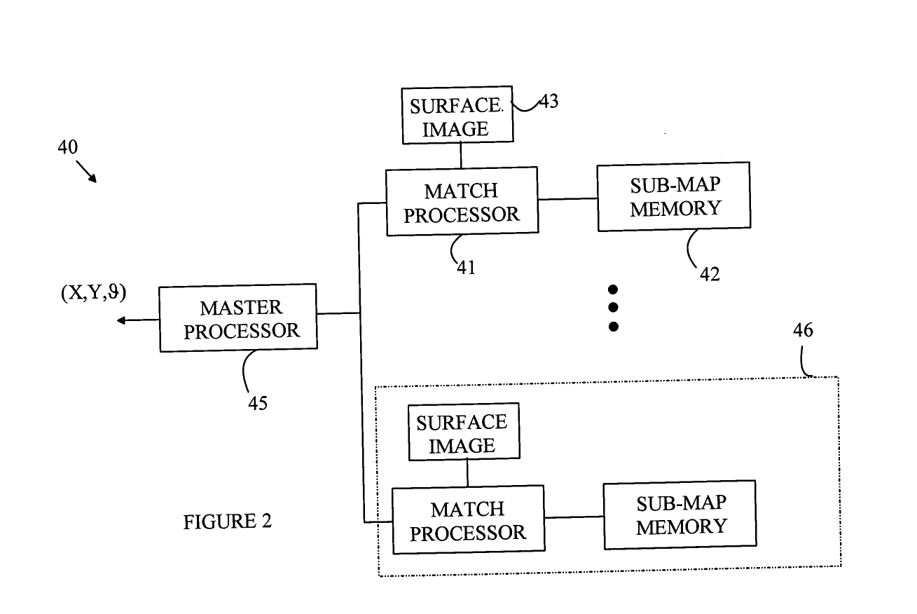

Refer now to FIG. 2, which illustrates a multi-processor system 40 for searching the sub-maps discussed above for a match to the surface image measured by imaging array 28. Each search processor 46 includes a match processor 41 and a sub-map memory 42 that stores the sub-maps for which that processor is responsible for searching. In the embodiment shown in FIG. 2, each search processor also stores a copy of the surface image in a memory 43. However, embodiments in which the surface image is shared by all of the processors from a common memory can also be utilized. Each match processor keeps track of the best fit that it has found between the surface image and the sub-maps stored in the memory attached to that match processor. The various match processors report the best fit found by each processor to a master processor 45 that outputs the results in terms of the displacement (x,y) and rotation angle, θ, to controller 26. Embodiments in which multi-processing system 40 is part of controller 26 can also be utilized.

The number of match processors to be used depends on the number of sub-maps and the time available between position updates. The minimum number of match processors is one. The maximum number is determined by the ratio of the surface image area to the total area of spherical element 11 that can be viewed by imaging array 28 and the number of rotations that are to be tested.

Refer again to FIG. 1. In one embodiment of the present invention, game controller 10 includes a plurality of game buttons that are used by the game player to signal various actions, such as shooting a gun, to the game. The buttons may be located on handle 12 as shown at 32 or on the support structure 13 as shown at 33. Buttons on the support structure can be directly connected to controller 26 by wires or the like. To simplify the drawing, the connection between button 33 and controller 26 has been omitted.

The preferred location for at least one of these buttons is on handle 12, since this allows the button to be pushed at the same time spherical element 11 is being moved and rotated. Controller 26 must be capable of sensing the state of the buttons. This poses a problem for the buttons on handle 12, as direct electrical connections between handle 12 and controller 26 require an interface that can accommodate the various movements of spherical element 11.

One method for sensing the state of button 32 utilizes an RF radio tag system. Since RF identification tags are known to the art, these devices will not be discussed in detail here. For the purposes of the present discussion, it is sufficient to note that controller 26 can be equipped with an RF transmitter and receiver. Each button is connected to a circuit that is powered by a portion of the energy in the incoming RF signal. The circuit in question transmits an RF signal on a different frequency. The return signal includes information specifying the state of the button, i.e., on or off.

Alternatively, a power source such as a battery can be included in handle 12 or elsewhere in the assembly that moves with spherical element 11. In this case, this power source can be utilized to power the above-described RF link or another communication link such as an infrared (IR) communication link that has a receiver in controller 26. IR links of this type are well known in the computing arts, and hence, will not be discussed here.

The above-described embodiments of the present invention have utilized a spherical element that moves relative to a fixed structure. However, other shapes of moveable elements can be utilized without departing from the teachings of the present invention provided the moveable element can be reproducibly positioned relative to a fixed structure.

The above-described embodiments of the present invention utilize a controller and memory that are part of the game controller hardware. However, embodiments in which the game controller outputs the image from the imaging element to the data processing system attached to the game controller can also be constructed. In such an embodiment, the map of the moveable element's surface is stored in the data processing system, and the computational engine of the data processing system is utilized to compare the measured image with the stored map. Such embodiments reduce the cost of the game controller.

Various modifications to the present invention will become apparent to those skilled in the art from the foregoing description and accompanying drawings. Accordingly, the present invention is to be limited solely by the scope of the following claims.

1. A game controller comprising:
a moveable element having an optically readable pattern on a surface thereof, said moveable element moving relative to a fixed position and having a position characterized by a relative position of said moveable element relative to said fixed position;
an imaging element that forms an image of a sub-area on said surface, said sub-area being determined by said relative position of said moveable element relative to said fixed position;
a memory for storing a map that specifies said readable pattern in each sub-area on said surface that can be imaged by said imaging element; and
a controller for comparing said image to said map to determine said position of said moveable element.

2. The game controller of claim 1 wherein said pattern comprises a plurality of randomly distributed spots.

3. The game controller of claim 1 wherein said controller generates a signal indicative of a position of said spherical element in terms of first and second orthogonal displacements from a reference position.

4. The game controller of claim 1 wherein said controller generates a signal indicative of a rotation of said moveable element about a predetermined axis on said moveable element.

5. The game controller of claim 4 wherein said moveable element comprises a handle.

6. The game controller of claim 5 wherein said handle comprises a shaft with a shaft axis parallel to said predetermined axis.

7. The game controller of claim 5 wherein said handle further comprises a push button having a state that is sensed by said controller.

8. The game controller of claim 1 wherein said map comprises a plurality of sub-maps that are rotated relative to one another.

9. The game controller of claim 1 wherein said controller comprises a plurality of search processors, each search processor comparing a portion of said map with said image formed by said imaging element.
